(19) United States
(12) Patent Application Publication
(10) Pub. No.: US 2018/0201244 A1
(43) Pub. Date: Jul. 19, 2018

(54) VEHICLE BRAKE CONTROL DEVICE

(71) Applicant: ADVICS CO., LTD., Kariya-shi, Aichi-ken (JP)

(72) Inventor: Kazuaki YOSHIDA, Nagoya-shi, Aichi-ken (JP)

(73) Assignee: ADVICS CO., LTD., Kariya-shi, Aichi-ken (JP)

(21) Appl. No.: 15/743,368

(22) PCT Filed: Jul. 22, 2016
(86) PCT No.: PCT/JP2016/071480

§ 371 Date: Jan. 10, 2018

(30) Foreign Application Priority Data
Jul. 24, 2015 (JP) 2015-146849

(51) Int. Cl. B60T 8/40; B60T 8/172; B60T 8/32; B60T 8/58

(52) U.S. Cl. CPC B60T 8/404; B60T 8/58; B60T 8/321; B60T 8/172

(57) ABSTRACT

When braking force is applied to a vehicle by the operation of a brake actuator, this control device, which is a vehicle brake control device, calculates the time to stop TTS on the basis of the relationship between the vehicle speed VS and the vehicle deceleration DVS. In addition, when the calculated time to stop TTS becomes less than a restriction determination time TTSTH, the control device stops the operation of the supply pumps of the brake actuator.

### TECHNICAL FIELD

The present invention relates to a vehicle brake control device included in a brake device configured to increase braking force applied to a vehicle independently from driver's brake manipulation.

### BACKGROUND ART

A typically known vehicle brake device includes a vacuum booster having a suction chamber and a transformation chamber connected to an inlet pipe and a vacuum pump of an engine. The transformation chamber and the suction chamber in the vacuum booster communicate with each other while no brake manipulation is executed, whereas the transformation chamber and the suction chamber are disconnected from each other during brake manipulation such that the transformation chamber is exposed to the atmosphere. There is generated differential pressure between the transformation chamber and the suction chamber, and the differential pressure aids brake manipulation force as driver's force of manipulating a brake pedal. If the suction chamber has low negative pressure, the differential pressure is less likely to increase and the vacuum booster configured as described above achieves less efficiency of aiding the brake manipulation force of the driver.

In a case where the vacuum booster is determined as having low efficiency of aiding brake manipulation force of the driver executing brake manipulation, the brake device executes brake assist processing of operating a brake adjustment mechanism to assist increase in hydraulic pressure in a wheel cylinder provided for each wheel. Even when the vacuum booster has such low aid efficiency, the brake adjustment mechanism operates to achieve application of appropriate braking force to the vehicle (e.g. Patent Literature 1).

In recent years, there have been spreading vehicles equipped with a diesel engine and vehicles configured to automatically stop an engine even during travel. A vacuum booster included in a brake device of such a vehicle easily comes into a state with low negative pressure in a suction chamber. The brake device is thus likely to execute the brake assist processing during brake manipulation, and the brake adjustment mechanism operates more frequently for increase in braking force. The brake adjustment mechanism operating frequently receives a larger load.

In view of this, the brake device disclosed in Patent Literature 1 is configured to restrict increase in braking force by operation of the brake adjustment mechanism when brake assist processing is being executed and hydraulic pressure in a master cylinder, which has hydraulic pressure changed by driver's brake manipulation, becomes less than critical aid pressure. Specifically, the brake adjustment mechanism includes a pump configured to operate to supply brake fluid into the wheel cylinder provided for each wheel. The pump is stopped when the hydraulic pressure in the master cylinder becomes less than the critical aid pressure, to restrict increase in braking force by operation of the brake adjustment mechanism. In comparison to a case where the pump keeps operating even when the hydraulic pressure in the master cylinder becomes less than the critical aid pressure, this configuration shortens pump operation time and correspondingly reduces the load applied to the brake adjustment mechanism.

### CITATIONS LIST

### Patent Literature

Patent Literature 1: JP 2010-143546 A

### SUMMARY OF INVENTION

### Technical Problems

The vehicle occasionally stops when the hydraulic pressure in the master cylinder remains not less than the critical aid pressure during the brake assist processing. The stopped vehicle needs no further increase in braking force applied to the vehicle. The brake device disclosed in Patent Literature 1, however, causes the pump of the brake adjustment mechanism to keep operating until the hydraulic pressure in the master cylinder becomes not less than the critical aid pressure even through the vehicle stops.

Under a condition that the vehicle stops while the brake assist processing is executed, the pump may be stopped to restrict increase in braking force by operation of the brake adjustment mechanism. However, the pump keeps operating until the vehicle stops even when the vehicle is decelerating with no need for further increase in braking force. This configuration is not regarded as achieving sufficient reduction in load applied to the brake adjustment mechanism.

This problem can arise also during brake processing other than the brake assist processing if the brake adjustment mechanism operates to apply braking force to the vehicle. A problem similar to the above may arise also during automatic brake processing of applying braking force to the vehicle in a state where a driver is not executing brake manipulation.

It is an object of the present invention to provide a vehicle brake control device configured to appropriately set timing of restricting increase in braking force by operation of a brake adjustment mechanism to achieve reduction in load applied to the brake adjustment mechanism.

### Solutions to Problems

In order to achieve the object mentioned above, a vehicle brake control device is provided to a brake device including a brake adjustment mechanism configured to adjust braking force applied to a vehicle. The brake control device includes a time calculator configured to calculate, in every predetermined control cycle, time to stop necessary for stopping the vehicle, in accordance with a relationship between vehicle speed and vehicle deceleration; and a controller configured to restrict increase in braking force by operation of the brake adjustment mechanism when the time to stop calculated by the time calculator becomes less than restriction determination time, in a state where the brake adjustment mechanism operates to apply braking force to the vehicle.

In the above configuration, when the time to stop calculated in every predetermined control cycle becomes less than the restriction determination time, it is determined that the braking force applied to the vehicle cannot be increased before the vehicle stops or the braking force can be increased only by a slight amount. It is determined that the brake adjustment mechanism does not need to operate for increase in braking force when the time to stop becomes less than the restriction determination time. Increase in braking force by operation of the brake adjustment mechanism is thus restricted in this case. Increase in braking force by operation of the brake adjustment mechanism can be restricted before the vehicle stops. Appropriately setting the timing of restricting increase in braking force by operation of the brake adjustment mechanism thus achieves reduction in load applied to the brake adjustment mechanism.

Even in a state where increase in braking force by operation of the brake adjustment mechanism is restricted after the time to stop becomes less than the restriction determination time, the time to stop calculated in this state occasionally becomes not less than the restriction determination time. In such a state, it is determined that the braking force can be increased before the vehicle stops. When increase in braking force is requested in such a state, the braking force needs to be increased quickly by operation of the brake adjustment mechanism. If increase in braking force by operation of the brake adjustment mechanism is restricted in such a state, there may be a longer time lag between a time point of actual request for increase in braking force and a time point of actual start of increase in braking force by operation of the brake adjustment mechanism.

In view of this, in the vehicle brake control device, the controller preferably allows increase in braking force by operation of the brake adjustment mechanism even during restriction of the increase in braking force by operation of the brake adjustment mechanism after the time to stop calculated by the time calculator becomes less than the restriction determination time, when the time to stop calculated by the time calculator subsequently becomes not less than the restriction determination time. In this configuration, increase in braking force by operation of the brake adjustment mechanism is allowed when the time to stop becomes not less than the restriction determination time. If increase in braking force is thereafter actually required, the braking force can be increased more quickly in comparison to a case where increase in braking force is still restricted at the time point.

In the vehicle including a wheel cylinder provided for each wheel, increase in hydraulic pressure in the wheel cylinder causes increase in braking force applied to the vehicle. The brake adjustment mechanism in such a vehicle brake device occasionally includes a pump configured to operate to supply brake fluid into the wheel cylinder. The brake adjustment mechanism is occasionally configured to allow increase in hydraulic pressure in the wheel cylinder while the pump is operating, and prohibit increase in hydraulic pressure in the wheel cylinder while the pump is stopped.

In the vehicle brake control device included in the brake device, the controller is configured to stop the pump to restrict increase in braking force by operation of the brake adjustment mechanism when the time to stop calculated by time calculator is less than the restriction determination time, while the vehicle is decelerating in a state where the brake adjustment mechanism operates to apply braking force to the wheel. The controller is also configured to operate the pump to allow increase in braking force by operation of the brake adjustment mechanism when the time to stop calculated by the time calculator is not less than the restriction determination time.

The vehicle deceleration is increased by increasing braking force applied to the vehicle due to increase in manipulation amount of a brake manipulation member. When the vehicle is decelerating with the brake manipulation member being manipulated, the manipulation amount of the brake manipulation member is occasionally increased before the vehicle stops. Due to responsiveness of the brake device, there is a slight time lag from such increase in manipulation amount until the braking force actually increases and vehicle deceleration increases. Even when the manipulation amount of the brake manipulation member is increased before the vehicle stops, the braking force is occasionally not increased before the vehicle stops due to delay in response or the like of the brake device. Such a time lag can be found preliminarily in accordance with properties of the vehicle.

Assuming that time to decelerate lasts from start of increase in manipulation amount of the brake manipulation member to start of increase in vehicle deceleration due to the increased manipulation amount, the restriction determination time can be set in accordance with the time to decelerate. In this configuration, in the state where the time to stop is less than the restriction determination time, it is determined that the vehicle deceleration does not increase before the vehicle stops even when the manipulation amount of the brake manipulation member is increased, or the vehicle deceleration increases only by a slight amount relative to increase in manipulation amount of the brake manipulation member. Accordingly, restricting increase in braking force by operation of the brake adjustment mechanism when the time to stop is less than the restriction determination time inhibits deterioration in drivability as well as reduces excessive operation of the brake adjustment mechanism for increase in braking force.

Even in the state where increase in braking force by operation of the brake adjustment mechanism is allowed, there is a time lag from operation start of the brake adjustment mechanism for increase in braking force to actual start of increase in vehicle deceleration. Even when the brake adjustment mechanism starts operating for increase in braking force before the vehicle stops, the vehicle occasionally stops with only slight increase in vehicle deceleration. Operation of the brake adjustment mechanism for increase in braking force is regarded as being unnecessary in this case.

Assuming that mechanical effect time lasts from operation start of the brake adjustment mechanism for increase in braking force to start of increase in vehicle deceleration due to increase in braking force by operation of the brake adjustment mechanism, in a state where braking force applied to the vehicle is allowed, the restriction determination time can be set in accordance with the mechanical effect time. In this configuration, in the state where the time to stop is less than the restriction determination time, it is determined that the vehicle deceleration does not increase before the vehicle stops even when the brake adjustment mechanism starts operating for increase in braking force, or the vehicle deceleration increases only by a slight amount relative to an operation amount of the brake adjustment mechanism. Accordingly, restricting increase in braking force by operation of the brake adjustment mechanism when the time to stop is less than the restriction determination time inhibits deterioration in drivability as well as reduces excessive operation of the brake adjustment mechanism for increase in braking force.

### BRIEF DESCRIPTION OF DRAWINGS

FIG. 1 is a schematic configuration diagram of a brake device including a control device as a vehicle brake control device according to an embodiment.

FIG. 2 is a schematic configuration diagram of a vacuum booster included in the brake device.

FIG. 3 is a timing chart indicating a state where the vacuum booster reaches critical aid to increase a difference between required braking force and actual braking force applied to a vehicle.

FIG. 4 is an explanatory flowchart of processing routine executed by the control device when a driver executes brake manipulation.

FIG. 5 is a timing chart indicating a state where vehicle deceleration is increased by increase in brake manipulation amount of the driver.

FIGS. 6(a) to 6(e) are timing charts indicating a state where the vehicle is decelerated by driver's brake manipulation; FIG. 6(a) indicates transition of vehicle speed, FIG. 6(b) indicates transition of vehicle deceleration, FIG. 6(c) indicates transition of a brake manipulation amount, FIG. 6(d) indicates transition of time to stop, and FIG. 6(e) indicates transition of supply pump operation.

FIGS. 7(a) to 7(e) are timing charts indicating a state where the vehicle is decelerated by driver's brake manipulation; FIG. 7(a) indicates transition of vehicle speed, FIG. 7(b) indicates transition of vehicle deceleration, FIG. 7(c) indicates transition of a brake manipulation amount, FIG. 7(d) indicates transition of time to stop, and FIG. 7(e) indicates transition of supply pump operation.

FIG. 8 is a timing chart indicating a state where vehicle deceleration is increased by operation of a brake actuator in a brake device including a vehicle brake control device according to another embodiment.

### DESCRIPTION OF EMBODIMENTS

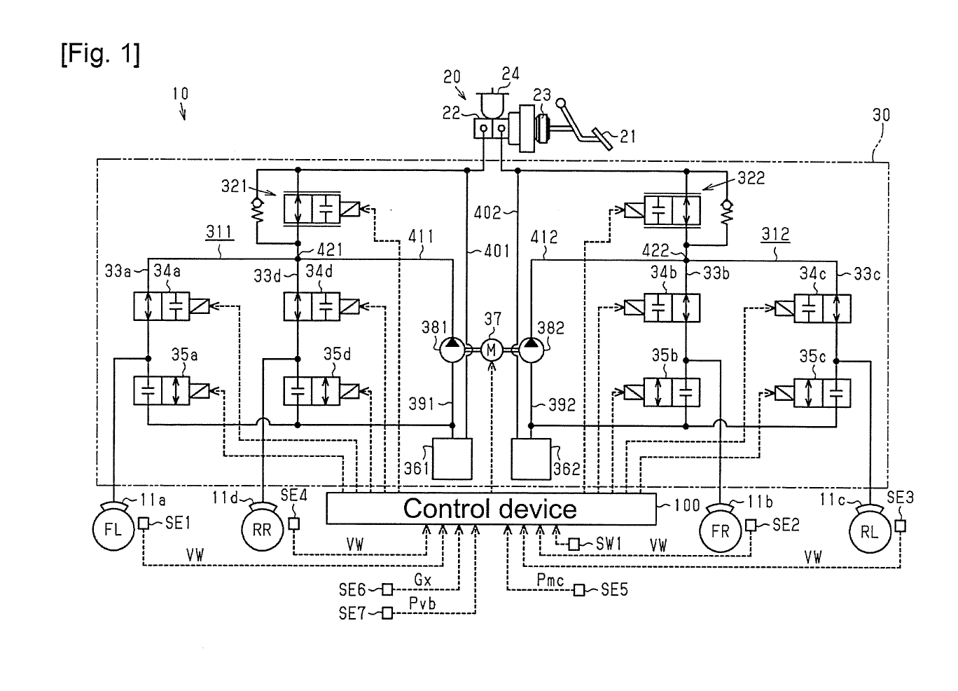

A vehicle brake control device achieved in accordance with an embodiment will now be described below with reference FIGS. 1 to 7(e).

FIG. 1 depicts an exemplary brake device 10 including a control device 100 as a vehicle brake control device according to the present embodiment. As depicted in FIG. 1, a vehicle equipped with the brake device 10 includes a plurality of wheels FL, FR, RL, and RR, and a plurality of wheel cylinders 11a, 11b, 11c, and 11d respectively corresponding to the wheels FL, FR, RL, and RR. The brake device 10 supplies the wheel cylinders 11a to 11d with brake fluid to increase hydraulic pressure in the wheel cylinders 11a to 11d. The wheels FL, FR, RL, and RR thus receive braking force according to the hydraulic pressure in the wheel cylinders 11a to 11d, respectively. The hydraulic pressure in the wheel cylinders 11a to 11d will also be called “WC pressure”.

The brake device 10 includes a hydraulic pressure generator 20 configured to generate hydraulic pressure in accordance with driver's force of manipulating a brake pedal 21, and a brake actuator 30 configured to individually adjust WC pressure in each of the wheel cylinders 11a to 11d. In the present description, driver's manipulation of the brake pedal 21 will also be called “brake manipulation” and force of manipulating the brake pedal 21 will also be called “brake manipulation force”.

The hydraulic pressure generator 20 includes a master cylinder 22, a vacuum booster 23 configured to aid brake manipulation force applied to the brake pedal 21, and an atmospheric pressure reservoir 24 reserving brake fluid. The master cylinder 22 receives brake manipulation force via the vacuum booster 23. There is generated hydraulic pressure according to the received brake manipulation force in the master cylinder 22. The hydraulic pressure in the master cylinder 22 will also be called “MC pressure”.

The brake actuator 30 is provided with dual hydraulic circuits 311 and 312. The first hydraulic circuit 311 is connected with the wheel cylinder 11a for a front left wheel and the wheel cylinder 11d for a rear right wheel, whereas the second hydraulic circuit 312 is connected with the wheel cylinder 11b for a front right wheel and the wheel cylinder 11c for a rear left wheel. Brake fluid flowing from the hydraulic pressure generator 20 into the first and second hydraulic circuits 311 and 312 is supplied to the wheel cylinders 11a to 11d.

The master cylinder 22 and each of the wheel cylinders 11a to 11d are connected via a fluid path provided with differential pressure control valves 321 and 322 configured as linear solenoid valves. The first hydraulic circuit 311 has a path 33a for the front left wheel and a path 33d for the rear right wheel, at positions closer to the wheel cylinders 11a and 11d than the differential pressure control valve 321. The second hydraulic circuit 312 similarly has a path 33b for the front right wheel and a path 33c for the rear left wheel, at positions closer to the wheel cylinders 11b and 11c than the differential pressure control valve 322. The paths 33a to 33d are provided with pressure holding valves 34a, 34b, 34c, and 34d as normally opened solenoid valves configured to operate to restrict increase in WC pressure in the wheel cylinders 11a to 11d, and pressure reducing valves 35a, 35b, 35c, and 35d as normally closed solenoid valves configured to operate to reduce WC pressure thereof, respectively.

The first and second hydraulic circuits 311 and 312 are connected to reservoirs 361 and 362 temporally reserving brake fluid flowing out of the wheel cylinders 11a to 11d via the pressure reducing valves 35a to 35d, and supply pumps 381 and 382 configured to operate in accordance with a driven motor 37, respectively. The reservoirs 361 and 362 are connected to the supply pumps 381 and 382 via intake flow paths 391 and 392, and are connected to paths at positions closer to the master cylinder 22 than the differential pressure control valves 321 and 322 via master flow paths 401 and 402, respectively. The supply pumps 381 and 382 are connected to connection portions 421 and 422 provided between the differential pressure control valves 321 and 322 and the pressure holding valves 34a to 34d, via supply flow paths 411 and 412, respectively.

When the motor 37 is driven, the supply pumps 381 and 382 collect brake fluid from the reservoirs 361 and 362 and the master cylinder 22 via the intake flow paths 391 and 392 and the master flow paths 401 and 402, and discharge the brake fluid into the supply flow paths 411 and 412, respectively. The differential pressure control valves 321 and 322 and the supply pumps 381 and 382 operate to generate differential pressure between the master cylinder 22 and the wheel cylinders 11a to 11d, so that the vehicle receives braking force according to the differential pressure. The brake actuator 30 disclosed in the present description exemplifies the “brake adjustment mechanism” configured to adjust braking force applied to the vehicle even when the brake pedal 21 is not manipulated.

As depicted in FIG. 1, the vehicle provided with the brake device 10 includes a brake switch SW1, wheel speed sensors SE1, SE2, SE3, and SE4 equal in number to the wheels FL, FR, RL, and RR, a pressure sensor SE5, an anteroposterior acceleration sensor SE6, and a negative pressure sensor SE7. The brake switch SW1 is configured to detect whether or not the brake pedal 21 is manipulated. The wheel speed sensors SE1 to SE4 are configured to detect wheel speed VW of the wheels FL, FR, RL, and RR, respectively. The pressure sensor SE5 is configured to detect MC pressure Pmc in the master cylinder 22. The anteroposterior acceleration sensor SE6 is configured to detect vehicle anteroposterior acceleration Gx. The negative pressure sensor SE7 is configured to detect negative pressure Pvb in a suction chamber 51 to be described later, of the vacuum booster 23. Information obtained by these detection systems is transmitted to the control device 100.

The control device 100 includes a microcomputer and a drive circuit configured to drive various valves and the motor 37. The control device 100 controls the brake actuator 30, specifically, the motor 37 and the various valves 321, 322, 34a to 34d, and 35a to 35d in accordance with the information received from the detection systems.

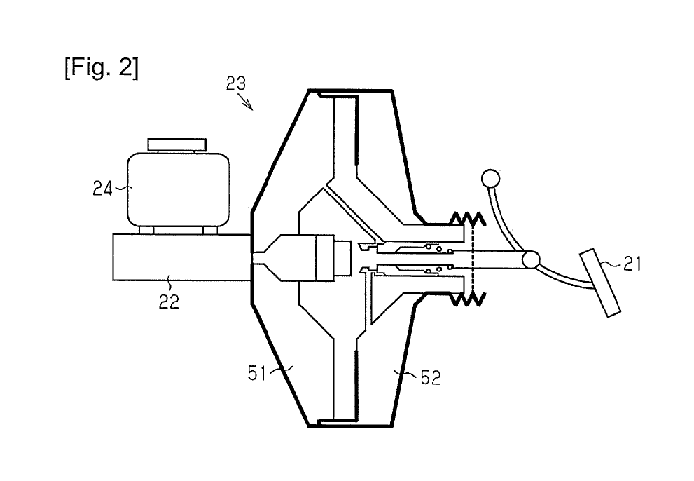

The vacuum booster 23 will be described next with reference to FIG. 2. FIG. 2 schematically depicts a state of the vacuum booster 23 with no driver's brake manipulation.

As depicted in FIG. 2, the vacuum booster 23 includes the suction chamber 51 and a transformation chamber 52. The suction chamber 51 is connected with an inlet pipe of the engine or the like. The suction chamber 51 thus has negative internal pressure while the engine is in operation. A difference obtained by subtracting the pressure in the suction chamber 51 from the atmospheric pressure is detected as the negative pressure Pvb by the negative pressure sensor SE7. In an engine such as a diesel engine that is less likely to cause increase in negative pressure in the inlet pipe, the suction chamber 51 is occasionally connected with a vacuum pump.

The transformation chamber 52 communicates with the suction chamber 51 while a driver is not executing brake manipulation. The transformation chamber 52 and the suction chamber 51 thus have substantially equal internal pressure in a continuous state with no execution of brake manipulation. In other words, the transformation chamber 52 has negative internal pressure. When the driver executes brake manipulation, the transformation chamber 52 and the suction chamber 51 are disconnected from each other, the transformation chamber 52 communicates with the outside, and the outside atmosphere flows into the transformation chamber 52. The pressure in the transformation chamber 52 approaches the atmospheric pressure to increase differential pressure between the transformation chamber 52 and the suction chamber 51. The vacuum booster 23 thus aids brake manipulation force applied to the brake pedal 21 by the driver. The brake manipulation force thus aided is applied to the master cylinder 22, and the MC pressure Pmc according to the applied brake manipulation force is generated in the master cylinder 22.

The transformation chamber 52 and the suction chamber 51 have the maximum differential pressure when the transformation chamber 52 has internal pressure equal to the atmospheric pressure. The maximum differential pressure leads to maximum aiding force of the vacuum booster 23, and the aiding force will not increase any more.

The transformation chamber 52 communicates with the suction chamber 51 again when the brake manipulation thereafter ends. Air then flows from the transformation chamber 52 into the suction chamber 51 to increase the pressure in the suction chamber 51, in other words, decrease the negative pressure Pvb in the suction chamber 51. The engine in operation causes the air in the suction chamber 51 to be exhausted to the inlet pipe to increase the negative pressure Pvb in the suction chamber 51.

If the driver ends brake manipulation while the engine is stopped, the negative pressure Pvb in the suction chamber 51 is not recovered and remains low. In a diesel engine not particularly including any throttle valve in the inlet pipe and hard to generate large negative pressure, start and end of brake manipulation repeated quicker than normal brake manipulation are less likely to cause increase in negative pressure Pvb in the suction chamber 51 even while the engine is in operation. When brake manipulation starts with such low negative pressure Pvb in the suction chamber 51, the differential pressure between the suction chamber 51 and the transformation chamber 52 (i.e. the maximum negative pressure) does not increase significantly and the vacuum booster 23 is less likely to aid brake manipulation force applied to the brake pedal 21. In other words, the vacuum booster 23 is less likely to have large aiding force. Particularly when the pressure in the suction chamber 51 is substantially equal to the atmospheric pressure, the differential pressure between the suction chamber 51 and the transformation chamber 52 becomes substantially “zero” and the vacuum booster 23 thus fails to aid brake manipulation force.

The outside atmosphere flows into the transformation chamber 52 during brake manipulation, and the pressure in the transformation chamber 52 is basically increased. In a case where the driver executes sudden brake manipulation, in other words, where brake manipulation force applied to the vacuum booster 23 has quite large increasing speed, the atmosphere occasionally flows insufficiently into the transformation chamber 52 to cause the pressure in the transformation chamber 52 to be decreased before becoming equal to the atmospheric pressure. With the decreased pressure in the transformation chamber 52, the differential pressure between the suction chamber 51 and the transformation chamber 52 temporarily tends to decrease and the vacuum booster 23 is thus less likely to aid brake manipulation force. In the present description, the state where increase in aiding force of the vacuum booster 23 cannot follow increase in brake manipulation force will be called “critical aid”.

The control device 100 as the brake control device according to the present embodiment is configured to operate the brake actuator 30 of the brake device 10 when determining that the vacuum booster 23 reaches the critical aid, to execute brake assist processing of assisting increase in WC pressure in the wheel cylinders 11a to 11d. Upon execution of brake assist processing, the brake actuator 30 operates to allow the WC pressure in the wheel cylinders 11a to 11d to be higher than the hydraulic pressure according to the MC pressure Pmc in the master cylinder 22.

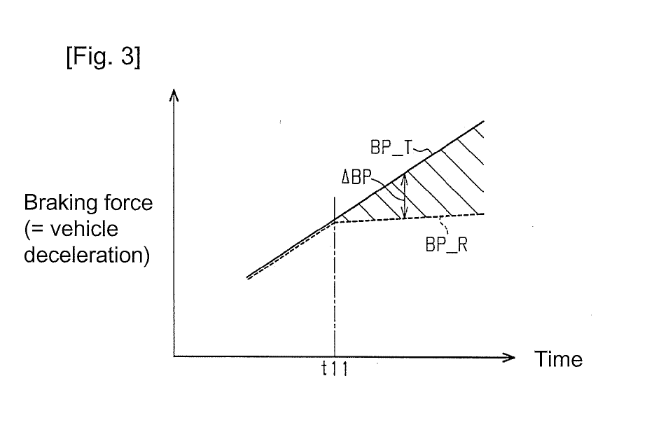

FIG. 3 indicates an exemplary case where brake assist processing does not start even when the vacuum booster 23 reaches the critical aid. The vacuum booster 23 is assumed to reach the critical aid at timing t11. As indicated in FIG. 3, when brake manipulation force of the driver increases, required braking force BP_T requested by the driver and actual braking force BP_R actually applied to the vehicle are less likely to have a large difference before the timing t11. In other words, required deceleration of the vehicle and actual deceleration of the vehicle are less likely to have a large difference.

However, brake manipulation force applied to the brake pedal 21 is hardly aided after the timing t11. The MC pressure Pmc in the master cylinder 22 is thus less likely to increase even when larger brake manipulation force is applied to the brake pedal 21. The actual braking force BP_R is thus smaller in increasing speed than the required braking force BP_T, and the actual braking force BP_R and the required braking force BP_T have a gradually increasing difference called a braking force difference ΔBP as a difference between the required deceleration and the actual deceleration.

When brake assist processing starts at the timing t11 when the vacuum booster 23 reaches the critical aid, the brake actuator 30 starts operating. In the brake actuator 30, with the supply pumps 381 and 382 each having a constant operation amount, the differential pressure control valves 321 and 322 each have an opening degree adjusted in accordance with the braking force difference ΔBP. The WC pressure in the wheel cylinders 11a to 11d approaches the hydraulic pressure according to the required braking force BP_T to inhibit increase in braking force difference ΔBP. In the present description, decreasing the opening degree of each of the differential pressure control valves 321 and 322 by change in output value (e.g. current value) from the control device 100 to the differential pressure control valves 321 and 322 while the supply pumps 381 and 382 are operating corresponds to operation of the brake actuator 30 for increase in braking force.

The differential pressure control valves 321 and 322 each include a valve seat, and a valve element seated on the valve seat. The valve element and the valve seat having a smaller gap therebetween in each of the differential pressure control valves are less likely to allow brake fluid to flow from a side of the wheel cylinders 11a to 11d to a side of the master cylinder 22. This gap thus corresponds to the opening degree of each of the differential pressure control valves 321 and 322. Pressing force as force of approaching the valve element toward the valve seat becomes larger if the control device 100 transmits a larger output value to the differential pressure control valves 321 and 322. This pressing force is applied opposite to brake fluid flowing from the side of the wheel cylinders 11a to 11d to the side of the master cylinder 22. When the supply pumps 381 and 382 discharge brake fluid, increase in output value leads to increase in pressing force and eventually to decrease in opening degree of the differential pressure control valves 321 and 322. This increases the differential pressure between side of the master cylinder 22 and the side of the wheel cylinders 11a to 11d, which interpose the differential pressure control valves 321 and 322 therebetween.

Even during such brake assist processing, the differential pressure between the suction chamber 51 and the transformation chamber 52 occasionally increases to have higher aid efficiency of the vacuum booster 23, depending on a manipulation condition of the brake pedal 21 or the like. Such increase in aid efficiency causes increase in MC pressure Pmc in the master cylinder 22. In this case, the braking force difference ΔBP decreases without execution of brake assist processing. This leads to decrease in output value transmitted from the control device 100 to the differential pressure control valves 321 and 322, as well as increase in opening degree of the differential pressure control valves 321 and 322. This leads to gradual decrease in correction amount of braking force by execution of brake assist processing. The supply pumps 381 and 382 are stopped when the correction amount becomes zero.

In contrast, depending on the condition of brake manipulation by the driver, the vehicle occasionally stops while the brake actuator 30 is in operation due to execution of brake assist processing, more specifically, the supply pumps 381 and 382 of the brake actuator 30 are in operation. Even upon request for increase in braking force applied to the vehicle, there is a time lag from the request until the output value transmitted from the control device 100 to the differential pressure control valves 321 and 322 increases for increase in braking force, the opening degree of each of the differential pressure control valves 321 and 322 is decreased, and the braking force actually starts increasing. With the supply pumps 381 and 382 in operation, even when the current value transmitted from the control device 100 to the differential pressure control valves 321 and 322 is increased and the differential pressure control valves 321 and 322 are decreased in opening degree in response to request for increase in braking force made before the vehicle stops, the vehicle occasionally stops before the braking force starts increasing or the braking force is increased only by a slight amount. In view of this, the vehicle brake control device according to the present embodiment is configured to stop the supply pumps 381 and 382 if braking force applied to the vehicle is determined as being temporally hard to further increase, in a state where the driver executes brake manipulation and the brake actuator 30 is in operation due to execution of brake assist control.

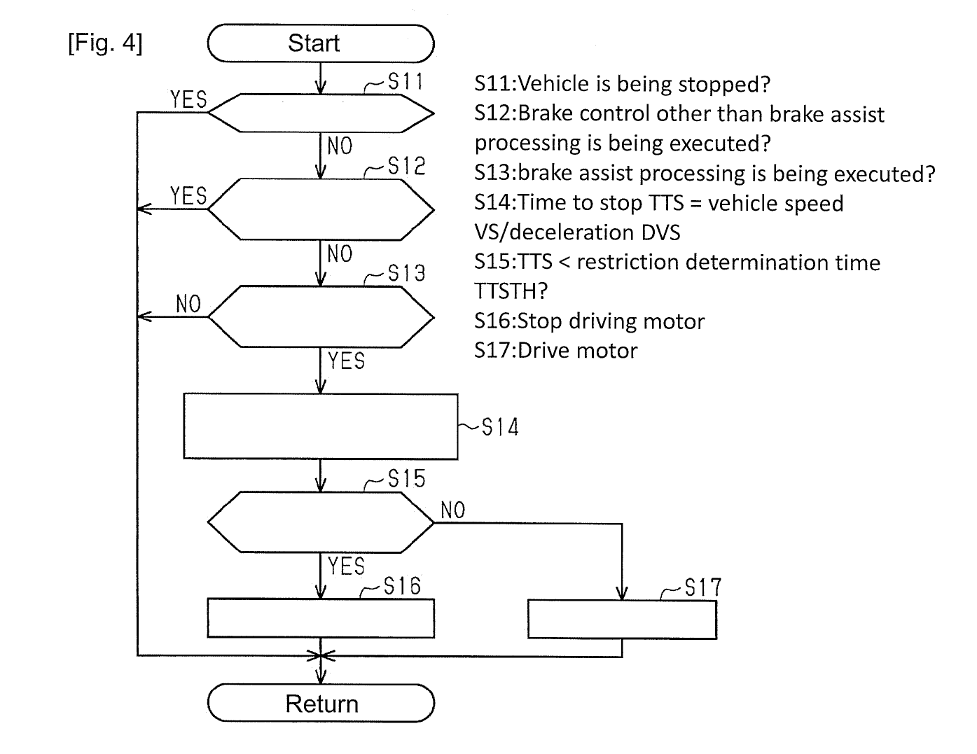

Described next with reference to the flowchart in FIG. 4 is processing routine executed by the control device 100 when the driver executes brake manipulation. This processing routine is executed in every preset control cycle while brake manipulation is executed.

As depicted in FIG. 4, in the present processing routine, the control device 100 determines whether or not the vehicle is stopped (step S11). For example, the control device 100 calculates vehicle speed VS in accordance with the wheel speed VW of at least one of the wheels FL, FR, RL, and RR detected by the wheel speed sensors SE1 to SE4, to determine that the vehicle is stopped if the vehicle speed VS is less than stop determination speed. In a case where the vehicle is already stopped (YES in step S11), the control device 100 temporarily ends the present processing routine. If the supply pumps 381 and 382 of the brake actuator 30 are still operating when the vehicle stops, the control device 100 executes processing routine other than the present processing routine to stop the supply pumps 381 and 382.

In another case where the vehicle is not stopped (NO in step S11), the control device 100 determines whether or not brake control other than brake assist control is executed (step S12). Such different brake control has a main object other than increasing vehicle deceleration. Examples of the different brake control include anti-lock braking control of controlling a slip amount of a control target wheel, and skid inhibiting control of applying braking force to a control target wheel for inhibition of skid of the vehicle.

In a case where different brake control is executed (YES in step S12), the control device 100 temporarily ends the present processing routine. In another case where different brake control is not executed (NO in step S12), the control device 100 determines whether or not brake assist control is executed (step S13). In a case where brake assist control is not executed (NO in step S13), the control device 100 temporarily ends the present processing routine.

In another case where brake assist control is executed (YES in step S13), the control device 100 calculates time to stop TTS as a temporal predictive value from the current time point until the vehicle stops (step S14). Specifically, the control device 100 time-differentiates the current vehicle speed VS to obtain vehicle deceleration DVS. The control device 100 then divides the current vehicle speed VS by the deceleration DVS to obtain a quotient (=VS/DVS) as the time to stop TTS. In the present description, the control device 100 exemplifies the “time calculator” configured to calculate, in every predetermined control cycle, the time to stop TTS required to stop the vehicle in accordance with a relationship between the vehicle speed VS and the vehicle deceleration DVS.

The control device 100 then determines whether or not the calculated time to stop TTS is less than restriction determination time TTSTH (step S15). If the time to stop TTS is less than the restriction determination time TTSTH, it is determined that, with the current braking force being kept, the braking force cannot be increased before the vehicle stops, or the braking force is increased only by a slight amount. When the time to stop TTS is less than the restriction determination time TTSTH, it is determined that the supply pumps 381 and 382 of the brake actuator 30 do not need to operate. A method of setting the restriction determination time TTSTH will be described later.

In a case where the time to stop TTS is less than the restriction determination time TTSTH (YES in step S15), the control device 100 stops driving the motor 37, in other words, stops the supply pumps 381 and 382 (step S16), and temporarily ends the present processing routine. In the present description, the control device 100 exemplifies the “controller” configured to restrict increase in braking force by operation of the brake actuator 30 when the time to stop TTS becomes less than the restriction determination time TTSTH in a state where the brake actuator 30 operates to apply braking force to the vehicle. In another case where the time to stop TTS is not less than the restriction determination time TTSTH (NO in step S15), the control device 100 drives the motor 37, in other words, operates the supply pumps 381 and 382 (step S17), and temporarily ends the present processing routine. The control device 100 allows increase in braking force by operation of the brake actuator 30 even during restriction of increase in braking force by operation of the brake actuator 30 after the time to stop TTS becomes less than the restriction determination time TTSTH, if the time to stop TTS calculated thereafter becomes not less than the restriction determination time TTSTH.

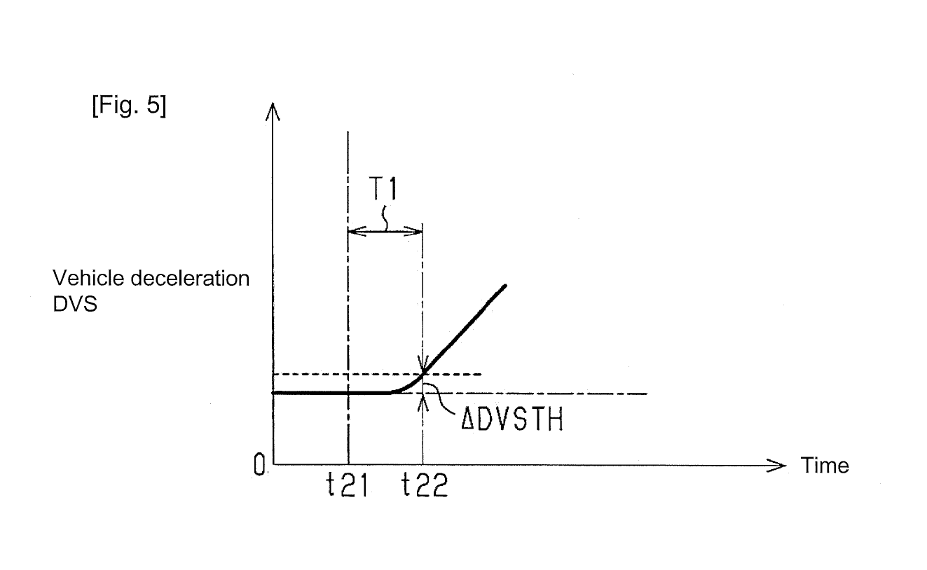

An exemplary method of determining the restriction determination time TTSTH will be described next with reference to FIG. 5.

As indicated in FIG. 5, when a brake manipulation amount X as a manipulation amount of the brake pedal 21 increases at first timing t21, the MC pressure Pmc in the master cylinder 22 then increases and the master cylinder 22 supplies the wheel cylinders 11a to 11d with brake fluid. This leads to increase in WC pressure in the wheel cylinders 11a to 11d and increase in braking force applied to the vehicle. The vehicle deceleration DVS then starts increasing, and has an amount of increase reaching an increase determination amount ΔDVSTH at second timing t22. The time lag from start of increase in brake manipulation amount X to start of increase in vehicle deceleration DVS is caused by delay in response of the brake device 10 or the like, and duration of the time lag can be found preliminarily. Time from the first timing t21 to the second timing t22 corresponds to “time to decelerate T1”. The restriction determination time TTSTH is set in accordance with the time to decelerate T1. In the vehicle brake control device according to the present embodiment, the restriction determination time TTSTH is exemplarily set to be equal to or slightly larger than the time to decelerate T1.

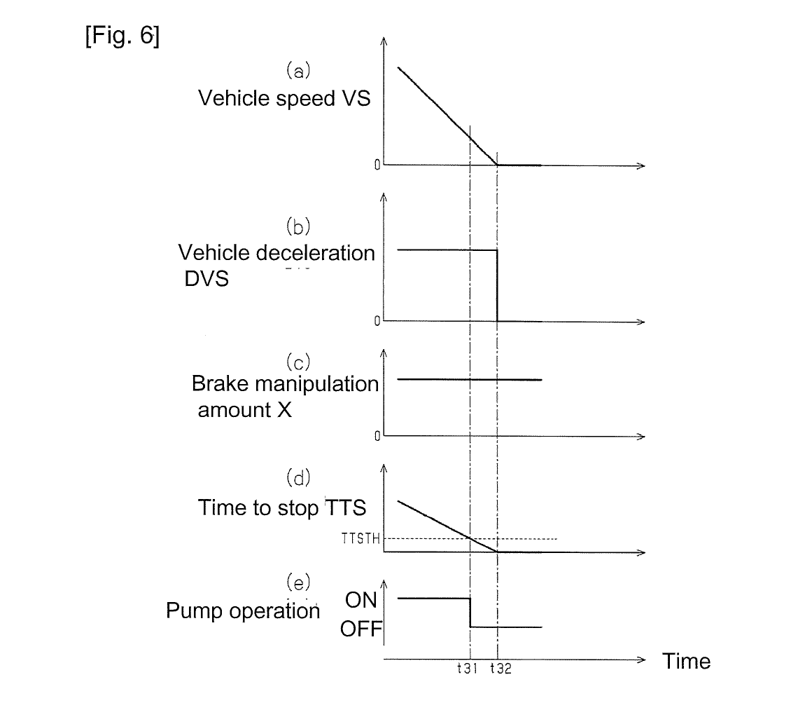

Described next with reference to the timing charts in FIGS. 6(a) to 6(e) is an exemplary function of executing brake assist processing in a state where the driver manipulates the brake pedal 21. FIGS. 6(a) to 6(e) exemplarily assume that the brake manipulation amount X has a constant value.

As indicated in FIGS. 6(a) to 6(e), the vehicle decelerates when the driver manipulates the brake pedal 21 and braking force is applied to the vehicle. Brake assist processing is executed in this case. Accordingly, the supply pumps 381 and 382 of the brake actuator 30 are operating, the output value received by each of the differential pressure control valves 321 and 322 is adjusted in accordance with the correction amount, and the differential pressure control valves 321 and 322 each have an opening degree according to the correction amount.

If brake assist processing is executed in this manner (YES in step S13), the time to stop TTS is calculated in every predetermined control cycle (step S14). In a case where the time to stop TTS is not less than the restriction determination time TTSTH (NO in step S15) before first timing t31, the supply pumps 381 and 382 keep operating (step S17). In other words, increase in braking force by operation of the brake actuator 30 is allowed. In another case where the time to stop TTS becomes less than the restriction determination time TTSTH (YES in step S15) at the first timing t31, the supply pumps 381 and 382 are stopped (step S16). Increase in braking force by operation of the brake actuator 30 is restricted in this case.

The vehicle then stops at second timing t32 when the time to stop TTS is kept less than the restriction determination time TTSTH (YES in step S11). Even in such a state where the vehicle is stopped, the output value is kept, which is set by execution of brake assist processing and is inputted to the differential pressure control valves 321 and 322. If the supply pumps 381 and 382 stop discharging brake fluid with the output value being kept, force against the pressing force decreases and the valve element is seated on the valve seat in each of the differential pressure control valves 321 and 322. That is, the differential pressure control valves 321 and 322 are closed.

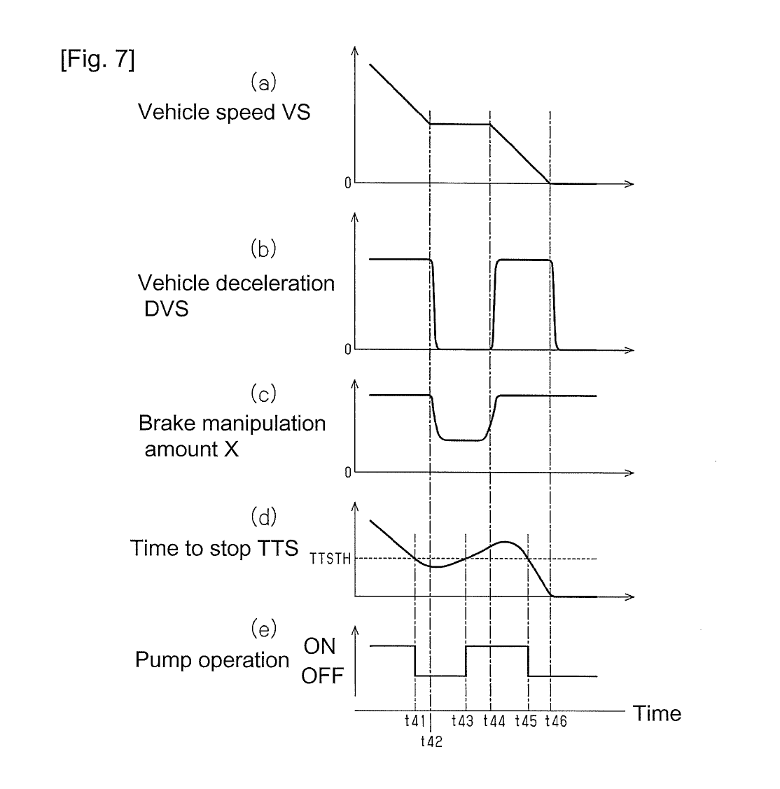

Described next with reference to the timing charts in FIGS. 7(a) to 7(e) is another exemplary function of executing brake assist processing in the state where the driver manipulates the brake pedal 21. FIGS. 7(a) to 7(e) exemplarily assume that the brake manipulation amount X is changed halfway.

As indicated in FIGS. 7(a) to 7(e), in a case where the time to stop TTS becomes less than the restriction determination time TTSTH (YES in step S15) at first timing t41, the supply pumps 381 and 382 are stopped (step S16). At second timing t42 when the vehicle is not yet stopped (NO in step S11), the manipulation amount of the brake pedal 21 by the driver, in other words, the brake manipulation amount X, decreases. This leads to decrease in vehicle deceleration DVS.

Such decrease in deceleration DVS leads to increase in time to stop TTS that is calculated in accordance with the relationship between the deceleration DVS and the vehicle speed VS. The time to stop TTS then becomes not less than the restriction determination time TTSTH (NO in step S15) at third timing t43 when the vehicle is not yet stopped, so that the supply pumps 381 and 382 start operating (step S17). Increase in braking force by operation of the brake actuator 30 is allowed in this case.

If the brake manipulation amount X starts increasing after the supply pumps 381 and 382 starts operating, the vehicle deceleration DVS starts increasing at fourth timing t44. The time to stop TTS then starts decreasing. The time to stop TTS again becomes less than the restriction determination time TTSTH (YES in step S15) at fifth timing t45 when the vehicle is not yet stopped, and the supply pumps 381 and 382 are stopped (step S17). The vehicle then stops at sixth timing t46 with the supply pumps 381 and 382 being stopped (YES in step S11).

The configurations and the functions described above achieve the following effects.

(1) In a state where the driver executes brake manipulation and the WC pressure in the wheel cylinders 11a to 11d is increased by execution of brake assist processing, the supply pumps 381 and 382 of the brake actuator 30 are stopped if the time to stop TTS is less than the restriction determination time TTSTH. Increase in braking force by operation of the brake actuator 30 can thus be restricted before the vehicle stops. Appropriately setting timing of restricting increase in braking force by operation of the brake actuator 30 achieves reduction in load applied to the brake actuator 30.

(2) In contrast, if the time to stop TTS is not less than the restriction determination time TTSTH, the supply pumps 381 and 382 of the brake actuator 30 operate. When increase in braking force is requested in the state where the time to stop TTS is not less than the restriction determination time TTSTH, the braking force can be increased quickly by decreasing the opening degree of each of the differential pressure control valves 321 and 322. This inhibits delay in response of the brake actuator 30 as well as deterioration in drivability.

(3) The vehicle brake control device according to the present embodiment sets the restriction determination time TTSTH to a value according to the time to decelerate T1 indicated in FIG. 5. The supply pumps 381 and 382 are stopped with the time to stop TTS being less than the restriction determination time TTSTH, to inhibit deterioration in drivability as well as reduce excessive operation of the supply pumps 381 and 382.

(4) As described above, the vehicle speed VS is calculated in accordance with the wheel speed VW of at least one of the wheels FL, FR, RL, and RR, and is thus hard to be calculated accurately during the different brake control. In view of this, the vehicle brake control device according to the present embodiment is configured not to calculate the time to stop TTS during the different brake control. This configuration prevents the supply pumps 381 and 382 from being erroneously stopped in a state where the supply pumps 381 and 382 are actually required to operate.

The embodiment described above can be modified into any one of the following different embodiments.

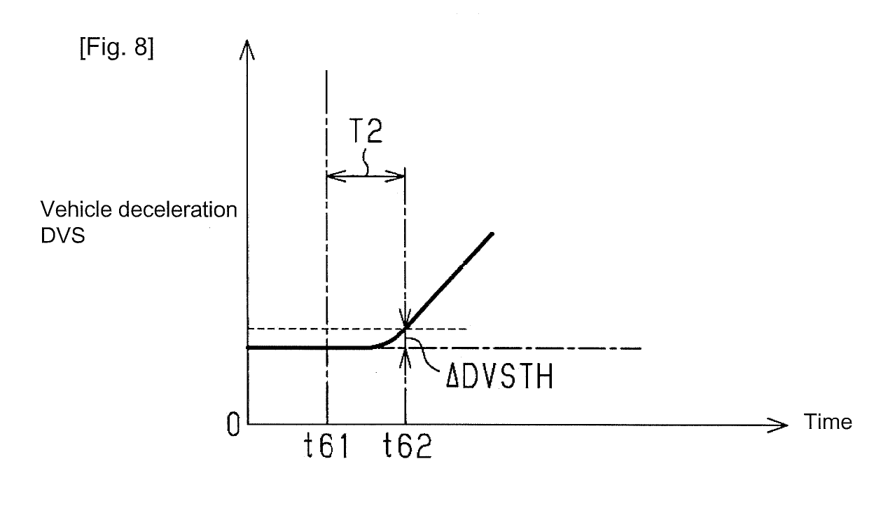

Even in the state where the supply pumps 381 and 382 of the brake actuator 30 are in operation, there is a time lag from start of decrease in opening degree of the differential pressure control valves 321 and 322 for increase in braking force to actual start of increase in vehicle deceleration DVS. As indicated in FIG. 8, assuming that the opening degree of each of the differential pressure control valves 321 and 322 starts decreasing at first timing t61, the deceleration has an amount of increase reaching the increase determination amount ΔDVSTH at subsequent second timing t62. Time from the first timing t61 to the second timing t62 corresponds to “mechanical effect time T2”. The restriction determination time TTSTH can alternatively be set in accordance with the mechanical effect time T2. For example, the restriction determination time TTSTH can be set to be equal to or slightly larger than the mechanical effect time T2. The restriction determination time TTSTH set in this manner also inhibits deterioration in drivability as well as reduces excessive operation of the supply pumps 381 and 382.

Transition of the time to stop TTS from a value not less than the restriction determination time TTSTH to a value less than the restriction determination time TTSTH often occurs while the opening degree of each of the differential pressure control valves 321 and 322 is decreasing due to execution of brake assist control. The transition occurs while braking force is increasing in this case. In the case where the transition occurs while the opening degree of each of the differential pressure control valves 321 and 322 is decreasing, the supply pumps 381 and 382 can be configured to keep operating even when the time to stop TTS becomes less than the restriction determination time TTSTH.

The brake device can be configured differently from the brake device 10 described above if the brake device is configured to increase the WC pressure in the wheel cylinders 11a to 11d irrelevantly from driver's brake manipulation.

The hydraulic pressure generator of the brake device can alternatively include a booster device other than the vacuum booster if the hydraulic pressure generator is configured to aid brake manipulation force of the driver. Examples of the different booster device include a hydraulic booster.

The hydraulic pressure generator may not include any booster device.

Examples of brake control of operating the brake actuator 30 include automatic brake processing of applying braking force to the vehicle while the driver is not executing brake manipulation. Execution of the automatic brake processing include operation of the supply pumps 381 and 382 as well as the differential pressure control valves 321 and 322 of the brake actuator 30. Even during such automatic brake processing, the time to stop TTS can be calculated in every predetermined control cycle and the supply pumps 381 and 382 can be stopped when the time to stop TTS becomes less than the restriction determination time TTSTH. Keeping the output value inputted to each of the differential pressure control valves 321 and 322 even when the supply pumps 381 and 382 are stopped enables closing the differential pressure control valves 321 and 322 and keeping braking force applied to the vehicle.

If the time to stop TTS is less than the restriction determination time TTSTH and the vehicle having stopped is determined as being kept stopped by keeping the braking force currently applied to the vehicle, the supply pumps 381 and 382 can optionally be stopped to restrict increase in braking force. In an exemplary state where the vehicle is traveling on a steeply ascending road surface, restricting increase in braking force because of the time to stop TTS being less than the restriction determination time TTSTH may lead to movement of the vehicle such as descending after the vehicle temporarily stops. In view of this, stop sustainable braking force can be calculated where appropriate as braking force continuously stopping the vehicle, to restrict increase in braking force if the time to stop TTS is less than the restriction determination time TTSTH and the braking force currently applied to the vehicle is not less than the stop sustainable braking force. In this configuration, increase in braking force is not restricted if the time to stop TTS is less than the Restriction determination time TTSTH but the braking force currently applied to the vehicle is less than the stop sustainable braking force. The supply pumps 381 and 382 keep operating in this case. The stop sustainable braking force can alternatively be obtained in consideration of inclination of a road surface under the vehicle, weight of the vehicle, or driving force such as creep force.

The above embodiment adopts the restriction determination time TTSTH for determination of whether or not to restrict increase in braking force and the equal restriction determination time TTSTH for determination of whether or not to allow increase in braking force. If the wheel speed VW referred to for calculation of the time to stop TTS includes noise, the noise may vary the time to stop TTS in a short period and generate hunting of repeating restricting increase in braking force and allowing increase in brake fluid, in other words, stopping and starting the supply pumps 381 and 382, in a short period. In order to inhibit such hunting, the restriction determination time TTSTH for determination of whether or not to allow increase in braking force can be set larger than the restriction determination time TTSTH for determination of whether or not to restrict increase in braking force.

The wheel speed VW can alternatively be filtered to remove a noise component therein, so that the time to stop TTS can be calculated in accordance with the filtered value. This also inhibits generation of the hunting.

Additionally recited below are technical ideas that can be found from the above embodiment and the other embodiments.

(A) Preferably, the brake device includes the master cylinder configured to generate hydraulic pressure according to manipulation force applied to the brake manipulation member,

the brake adjustment mechanism includes the pump configured to operate to supply brake fluid into the wheel cylinder provided for each wheel,

the controller operates the brake adjustment mechanism when the brake manipulation member is manipulated, to execute brake assist control of assisting increase in hydraulic pressure in the wheel cylinder, and

during the brake assist processing, the controller stops the pump when the time to stop calculated by the time calculator is less than the restriction determination time, and operates the pump when the calculated time to stop is not less than the restriction determination time.

1. A vehicle brake control device provided to a brake device including a brake adjustment mechanism configured to adjust braking force applied to a vehicle, the vehicle brake control device comprising:
a time calculator configured to calculate, in every predetermined control cycle, time to stop necessary for stopping the vehicle, in accordance with a relationship between vehicle speed and vehicle deceleration; and
a controller configured to restrict increase in braking force by operation of the brake adjustment mechanism when the time to stop calculated by the time calculator becomes less than restriction determination time, in a state where the brake adjustment mechanism operates to apply braking force to the vehicle.

2. The vehicle brake control device according to claim 1, wherein
the controller allows increase in braking force by operation of the brake adjustment mechanism even during restriction of the increase in braking force by operation of the brake adjustment mechanism after the time to stop calculated by the time calculator becomes less than the restriction determination time,
when the time to stop calculated by the time calculator subsequently becomes not less than the restriction determination time.

3. The vehicle brake control device according to claim 2, wherein
the vehicle includes a wheel cylinder provided for each wheel and configured to allow increase in braking force applied to the vehicle by increase in hydraulic pressure in the wheel cylinder,
the brake adjustment mechanism includes a pump configured to operate to supply brake fluid into the wheel cylinder, and is configured to allow increase in hydraulic pressure in the wheel cylinder while the pump is operating and prohibit increase in hydraulic pressure in the wheel cylinder while the pump is stopped, and
the controller is configured to:
when the vehicle is decelerating in a state where the brake adjustment mechanism operates to apply braking force to the vehicle,
stop the pump if the time to stop calculated by the time calculator is less than the restriction determination time, to restrict increase in braking force by operation of the brake adjustment mechanism, and
operate the pump if the time to stop calculated by the time calculator is not less than the restriction determination time, to allow increase in braking force by operation of the brake adjustment mechanism.

4. The vehicle brake control device according to claim 1, wherein
the vehicle deceleration is increased by increasing braking force applied to the vehicle due to increase in manipulation amount of a brake manipulation member, and
assuming that time to decelerate lasts from start of increase in manipulation amount of the brake manipulation member to start of increase in vehicle deceleration due to the increased manipulation amount,
the restriction determination time is set in accordance with the time to decelerate.

5. The vehicle brake control device according to claim 1, wherein
assuming that mechanical effect time lasts from operation start of the brake adjustment mechanism for increase in braking force to start of increase in vehicle deceleration due to increase in braking force by operation of the brake adjustment mechanism, in a state where increase in braking force applied to the vehicle is allowed,
the restriction determination time is set in accordance with the mechanical effect time.

6. The vehicle brake control device according to claim 2, wherein
the vehicle deceleration is increased by increasing braking force applied to the vehicle due to increase in manipulation amount of a brake manipulation member, and
assuming that time to decelerate lasts from start of increase in manipulation amount of the brake manipulation member to start of increase in vehicle deceleration due to the increased manipulation amount,
the restriction determination time is set in accordance with the time to decelerate.

7. The vehicle brake control device according to claim 2, wherein
assuming that mechanical effect time lasts from operation start of the brake adjustment mechanism for increase in braking force to start of increase in vehicle deceleration due to increase in braking force by operation of the brake adjustment mechanism, in a state where increase in braking force applied to the vehicle is allowed,
the restriction determination time is set in accordance with the mechanical effect time.

8. The vehicle brake control device according to claim 3, wherein
the vehicle deceleration is increased by increasing braking force applied to the vehicle due to increase in manipulation amount of a brake manipulation member, and
assuming that time to decelerate lasts from start of increase in manipulation amount of the brake manipulation member to start of increase in vehicle deceleration due to the increased manipulation amount,
the restriction determination time is set in accordance with the time to decelerate.

9. The vehicle brake control device according to claim 3, wherein
assuming that mechanical effect time lasts from operation start of the brake adjustment mechanism for increase in braking force to start of increase in vehicle deceleration due to increase in braking force by operation of the brake adjustment mechanism, in a state where increase in braking force applied to the vehicle is allowed,
the restriction determination time is set in accordance with the mechanical effect time.
